(19) United States
(12) Patent Application Publication
(10) Pub. No.: US 2006/0038356 A1
(43) Pub. Date: Feb. 23, 2006

(54) Seal structure for sealing the inlet exit passageway of an elongated object

(76) Inventor: Reijo Lehtinen, Raahe (FI)

Correspondence Address: CONNOLLY BOVE LODGE & HUTZ LLP, SUITE 800, 1990 M STREET NW, WASHINGTON, DC, 20036-3425, US

(21) Appl. No.: 10/522,269

(22) PCT Filed: Jul. 9, 2003
(86) PCT No.: PCT/FI03/00556

§ 371 Date: Jan. 25, 2005

(30) Foreign Application Priority Data
Jul. 26, 2002 (FI) 20021414

(51) Int. Cl. F16J 15/32

(52) U.S. Cl. 277/549

(57) ABSTRACT

The invention relates to a seal structure for scaling the inlet/exit gate passageway of an elongated object (1) from a process cavity (A, B) or into such a cavity. The seal structure comprises sheet-metal structures, which essentially delineate the passageway and are removably mounted on the frame structure (3) of said process cavity, and a sweeping seal element (13) enclosing the passageway. The sheet-metal element structures comprise at least two sheet-metal elements (14, 15, 15x) that have a shape taperingly departing from the frame structure (3) of the process cavity so as to be inclined in the nominal travel direction of the object (1) are kept compressed mutually against each other so as to hold a seal element (13, 13x) therebetween.

The invention relates to a seal construction suitable for providing a sealed passage at inlet/exit end gates serving to pass elongated objects via a process cavity. Examples of such processes taking place in a given sealed environment include the manufacture of pipes, plastic pipes in particular, by die extrusion, fabrication of different continuous sections, coating extrusion of cable jackets/sheaths, etc.

In these kinds of manufacturing lines, the elongated product being fabricated or processed is passed in its longitudinal direction, generally as a substantially continuous object, through one or more process cavities. Frequently the conditions prevailing in the process cavities are such that require the cavity to be isolated from its environment or possibly from another space, wherein the product is subjected to the next process step.

For instance, in the manufacture of plastic pipes by die extrusion, the extrusion cavity is generally operated at a vacuum. The final outer dimension of the pipe is sized in this cavity by expanding the prefabricated hot pipe parison exiting the extruder by means of a pressure differential applied between the interior and exterior of the pipe parison. Herein, the pipe parison is passed through a cylindrical sleeve, whereby the parison is expanded against the interior bore of the calibration sleeve by the above-mentioned differential pressure applied on the pipe. The shape and outer diameter of the pipe thus calibrated is stabilized by cooling the material of the pipe. Generally, cooling takes place in plural successive steps. However, cooling is carried out at least partially in the same process step wherein the final outer dimension of the pipe is defined in a step called pipe sizing, or calibration.

The isolation of the process cavity from its environment or other process steps is accomplished by means of annular disc seal elements adapted to the product inlet/exit gate opening or openings and having their passageway(s) dimensioned to cope with the product being processed by way of forming a sliding contact along the product surface. Different kinds of support fixtures are employed to mount the gate seals on other structures of the process cavity. Herein, also the support fixtures must themselves be sealed in order to retain the process cavity or cavities under their appropriate operating conditions by, e.g., maintaining the process cavity at a sufficient partial vacuum in regard to the ambient pressure.

In calibration and cooling apparatuses generally implemented as elongated chambers in plastic pipe extruder machines, the support fixture means of planar gate seals comprise a set of annular flat flanges. The flanges must be available as a set of different sizes to provide gate seals for manufacturing pipes of different diameters.

As a primary component, the seal assembly comprises a mounting flange with an outer diameter dimensioned substantially compatible with the cross-sectional dimension of the process cavity and equipped with suitable means at the flange outer periphery for mounting the flange to the end or intermediate wall structures of the process cavity. Mounting of the flange to the process cavity structures is generally implemented using screw joints having the fixing screws spaced equidistantly about the mounting flange periphery. At the center of the mounting flange is provided a circular opening having a diameter substantially larger than the outer diameter of the pipe to be manufactured.

Into the opening of the mounting flange is adapted a seal flange assembly of a smaller inner diameter central opening serving to properly align the planar end gate seals. This seal assembly further includes a support flange having a central opening with a diameter slightly larger than the outer diameter of the pipe being manufactured. The support flange is mounted so as to support the planar end gate seal from the interior side of the process cavity, that is, from the side to be maintained at the lower pressure. Onto the support flange is fixed a seal mounting ring having substantially the same outer diameter, whereby the planar end gate seal remains clamped between the flange and the mounting ring. The mounting ring and the support flange are together tightened against the mounting flange thus also fixing the seal placed between them in place. Fixing the gate seal is generally implemented using a number of screws spaced equidistantly about the mounting flange inner periphery. Both the mounting flange and the support flange must be sealed with their own ring seals to their mounting base.

The seal assembly with its planar end gate seal must be dimensioned separately for each outer diameter size of pipes to be manufactured. For structural constraints, only a limited span of standardized nominal pipe sizes can be covered by one seal assembly set compatible with a given mounting flange having a fixed-diameter opening. Pipes having a size larger or smaller of the those covered by the seal assembly set require a mounting flange of a respectively larger or smaller diameter opening with compatible sets of planar end gate seals.

An obvious shortcoming of these conventional seal structures is firstly their massive construction. Such a robust design is necessary to make the annular disc flanges and rings sufficiently rigid to endure the harsh operating conditions without warping and thus maintaining the required integrity of the sealed construction. The handling of the massive flanges during pipe size changes is clumsy. Furthermore, leakproof mounting of the flanges and seals, particularly to gate openings located in the interior of a process cavity, is also awkward. Still further problems are encountered in arranging intermediate storage facilities for the flange sets. Due to the planar disc structure of the flanges, the seal is aligned in a plane perpendicular to the pipe passing through the seal. As a result, the planar end gate seal performing a sweeping action at the seal area is subjected to a severe flexural stress.

More specifically, the problems of the prior-art seal structures can be solved by virtue of the seal structure according to the invention characterized by what is stated in appended claim 1.

In the following, the invention will be examined in more detail by making reference to the appended drawings in which

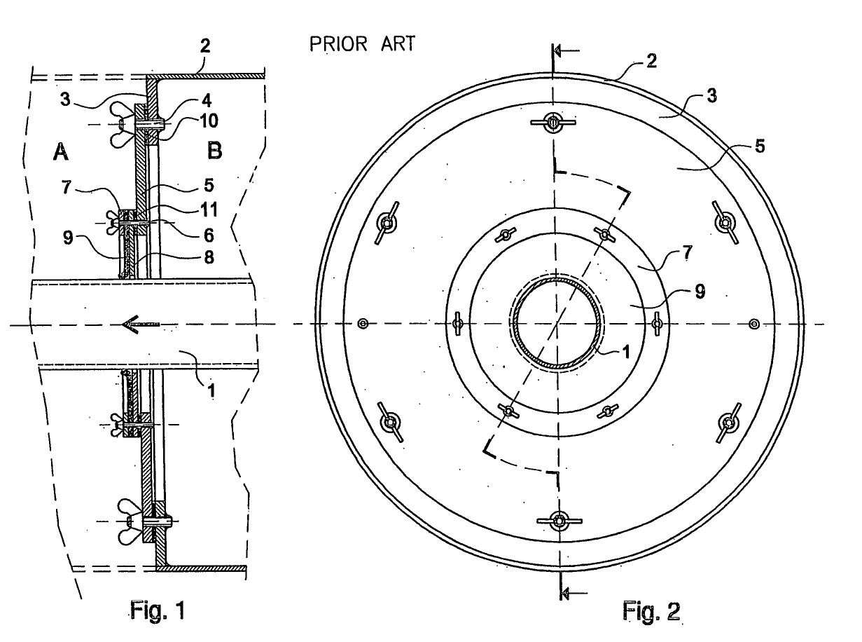

FIG. 1 shows a sectional view of a prior-art seal construction in an exemplary embodiment;

FIG. 2 shows the end of a process cavity having the seal construction of FIG. 1 adapted thereto;

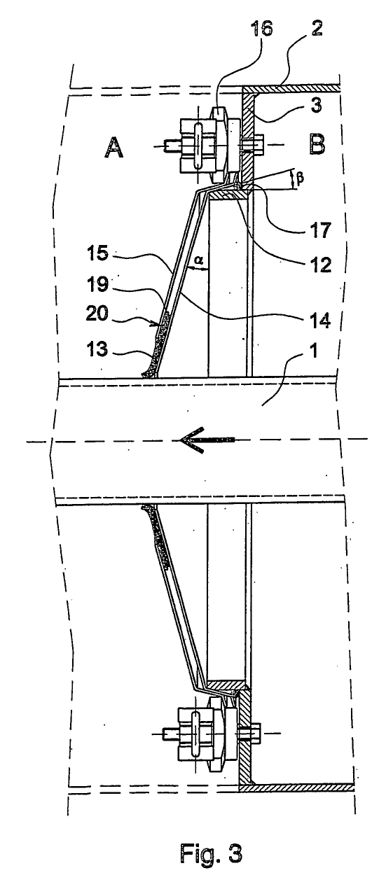

FIG. 3 shows a sectional view of a seal structure according to the invention adapted to the exemplary embodiment of FIG. 1;

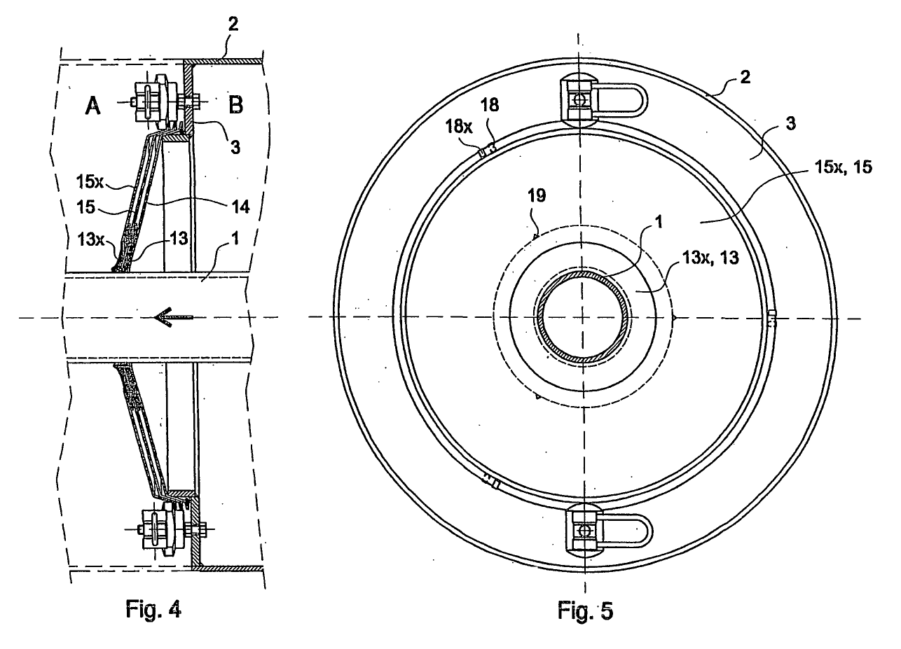

FIG. 4 shows a modification of the seal structure of FIG. 3; and

FIG. 5 shows the end of a process cavity with a seal structure according to the invention adapted thereto.

Referring to FIG. 1, therein is shown an exemplary embodiment of the prior art planar end gate seal adapted to the exit end of a calibration sleeve cavity B of a die extrusion line of plastic pipes. Generally, the calibration sleeve cavity B is maintained at a lower pressure than cavity A whereto an extruded pipe 1 is passed after the steps of outer diameter calibration and pipe cooling. Cavity A may be a postprocessing cavity or the exit space of the pipe manufacturing process.

The exit end of the calibration cavity is provided with an annular flange 3 fixed by welding to a cylindrical wall 2 of the cavity, whereby the flange forms a portion of the conventional structure of the calibration cavity. Equispaced around the outer periphery of this flange are fixed axially projecting threaded stud bolts 4 serving to tighten the gate seal structure to the end of the cavity. The seal assembly includes a mounting flange 5 implemented as a ring flange. Equidistantly spaced as described above, about the central opening of this flange are located axially projecting threaded stud bolts 6 for mounting an annular end seal assembly. The annular end seal assembly comprises two parts having an essentially equal outer diameter, namely: a mounting ring 7 and an annular flange 8. Between the mounting ring and the annular flange is adapted a planar seal 9 that in a sweeping fashion provides a seal against the outer surface of pipe 1 being extruded. The annular flange 8 housed in the interior space of calibration cavity B is designed to serve as support flange having its central opening made slightly larger than the outer diameter of pipe 1 being manufactured. Flange 8 gives the seal 9 the required support against the loading imposed by the differential pressure between cavities A and B. Between the annular flange 3 forming a portion of cavity B and the mounting flange 5 is placed an annular gasket seal 10 and, in the same fashion, an annular gasket seal 11 is placed between mounting flange 5 and support flange 8. The layout of the assembly as seen from cavity A is shown in FIG. 2, wherein the same reference numerals indicate the same components as those shown in FIG. 1.

FIG. 3 shows the same assembly layout as FIG. 1, now implemented using a cavity seal structure according to the invention. Cavity B is assumed to be a vacuum cavity such as a calibration cavity, wherefrom pipe 1 being manufactured exits into cavity A. Cavity A in turn may be a postprocessing cavity or a space receiving the finished pipe from the process.

To the ring flange 3, which forms an integral frame portion of the calibration cavity, is connected by welding an annular member 12 serving as a guide/backing ring in the exemplary embodiment of the cavity seal structure according to the invention.

Basically, the actual seal element 13 of the cavity seal structure is similar to the elastic planar end gate seal used in prior-art constructions, however, lacking the holes conventionally needed for seal mounting pins. The seal has a central opening with a diameter slightly smaller than the outer diameter of the pipe being manufactured, whereby the seal forms a sweeping contact along the outer surface of pipe 1 passing through the seal opening. To keep the seal in its proper operating position, the seal structure embodiment of FIG. 3 includes two sheet-metal elements 14 and 15. In the illustrated structure, the sheet-metal elements are worked so that either of them comprises a cup-like piece of revolution having its axis of revolution coinciding with the longitudinal axis of the pipe exiting the calibration cavity B. A central opening is provided at the center of the sheet-metal elements of revolution for the passage of pipe 1 therethrough. The cup-like shape of the sheet-metal elements is adapted to project from the end of the calibration cavity B toward the same direction with the travel of pipe 1 passing through. With the help of their fixing means, the sheet-metal elements 14 and 15 are kept pressed against each other, whereby the seal element 13 stays clamped between the edges of the openings of the sheet-metal elements 14 and 15. In the illustrated embodiment, the sheet-metal element 14 serves as a support flange equipped with an opening slightly larger than the outer diameter of the pipe 1 passing therethrough. Hence, the sheet-metal element 14 backs the actual seal element against loads imposed by the lower pressure of cavity B in regard to the pressure prevailing in cavity A. Hence, the passageway opening made in sheet-metal element 15 acting as a mounting flange in the cavity seal structure may be oversized yet keeping in mind that sufficient support to the actual seal element 13 is secured at all times.

An essential feature in the adaptation of the sheet-metal elements 14 and 15 into the cavity seal structure is the slanted wall of the elements taperingly inclined in the downstream travel direction of pipe 1 from the outer fixed periphery of the elements so as to give the sheet-metal element its cup-like shape. The angle a defining the conical shape of the sheet-metal element is advantageously in the range of 15-20° in regard to a plane perpendicular to the longitudinal axis of the pipe being manufactured. In the embodiment of FIG. 3, the sheet-metal elements are flaringly swaged in a close vicinity of their outer edge so as to form a rim aiding the alignment and seating of the element in regard to the annular member 12. Advantageously, the sheet-metal elements are swaged at their outer periphery to a flaring angle β of about 15°. The thus formed element rims also contribute substantially to the dimensional stability of the shape of the sheet-metal elements 14 and 15.

The sheet-metal elements 14 and 15 are appropriately mounted in place on the end of the calibration cavity B by way of stacking the elements against the annular member 12 so as to properly align the rim of the underlying sheet element in regard to the annular member. The sheet-metal elements are compressed against the annular member 12 by means of a suitable locking means 16 that may be a toggle clamp, for instance. Between the annular flange 3 and next underlying sheet-metal element 14 of the stacked seal assembly, a seal must be adapted such as the ring seal 17 shown in FIG. 3. The seal 17 shall be selected such that offers appropriate compressibility when the sheet-metal elements are seated against the annular member 12 under the compressive force of the locking means 16.

This kind of seal structure having the sheet-metal elements 14 and 15 equipped with the above-mentioned swaged rim operates in a self-centering fashion when used in conjunction with the annular member 12. Hence, the mounting of the cavity seal can be performed without the need for any specific installation guides or accurate alignment in regard to the seal fixing bolts or the like elements.

Should a certain application require the seal 13 to provide an improved sealing capability, e.g., when cavities A and B are operated without having a differential pressure therebetween so as to have a lower pressure in cavity B in regard to cavity A, the seal element structure according to the invention may be simply manyfolded. This kind of arrangement is shown in the appended diagram of FIG. 4. In the seal assembly shown therein, onto the outer sheet-metal element 15 is mounted a similar sheet-metal element 15x, whereby between the adjoining elements is placed a seal element 13x identical to seal element 13. Obviously, the possible need of manyfolding the number of seal elements in the cavity seal structure must be taken into account in the selection of the stud bolt length of the locking means 16. One feasible technique of further enhancing the sealing efficiency of the manyfolded structure is to bring the spaces between the sheet-metal elements 14, 15, 15x to a vacuum and simultaneously apply the same vacuum to the spaces between the actual manyfolded seal elements 13 and 13x by way of, e.g., making grooves on the sheet-metal element 25 intended to be interposed between the actual seal elements such that the grooves extend from the rim of the central opening of the sheet-metal element radially outward beyond the clamping area of the actual seal element. In lieu of a vacuum, in certain cases it may alternatively be advantageous to apply a lubricant such as water, for instance, at a low head between the adjacent seal elements. Obviously, these arrangements also require the sheet-metal elements connected to the surrounding spaces to have a solid and fully sealed structure.

The installation of the seal structure, whether as a conventional or a manyfolded assembly, is simplified if the cavity seal components are preassembled into a ready-to-use assembly secured by suitable clamp elements 18, 18x as shown in the appended diagram of FIG. 5. The shape of these clamp elements may be designed such as is necessary to implement by means of appropriately placing the clamps about the periphery of the sheet-metal elements 14, 15, 15x a sufficient clamping force between the sheet-metal elements to keep the seal elements 13, 13x between the sheet-metal elements also during operation. One feasible alternative to provide or augment mutual compression between the steel-metal elements 14, 15, 15x is to bring the spaces between the sheet-metal elements to a vacuum. Obviously, this also necessitates a solid structure from the sheet-metal elements and a sealed mounting thereof to the process cavity structures.

Further augmentation to the assembly of the cavity seal structure is obtained by way of providing the sheet-metal elements 15, 15x with guides 19 adapted to delineate the alignment of the seal element 13, 13x in regard to the center of the respective sheet-metal element 15, 15x. The guides can be implemented in the form of, e.g., tabs punched with the help of an appropriate cutting tool from the exterior side of the sheet-metal element to the interior side thereof.

The immediate vicinity of the center opening of the sheet-metal element 15, 15x may also be treated in an appropriate fashion such as roughening, patterning or coating of the surface 20 thereof facing the seal element in order to secure a stable position of the seal element 13, 13x in place. Respectively, the surface of the sheet-metal elements 14, 15, 15x facing the seal elements can be treated so as to improve the leakproofness of the interface between the sheet-metal element and seal element 13, 13x.

The fixing means of the cavity seal structure, of which the above-mentioned quick-lock fixing means 16 are an exemplary embodiment, may be implemented using any conventional construction suitable for the purpose.

In the appended diagrams, the seal structure is illustrated in applications primarily intended to seal the exit point of a pipe from a process cavity. Respectively, the seal may be mounted on the inlet side of a pipe or the like product to be processed entering a similar cavity or passing through an intermediate wall separating two cavities, advantageously employing the invention in a case needing a sealed passageway for a product passing from a cavity of a lower pressure to a cavity of a higher pressure. The cavity in question need not further be a closed space but instead, may comprise a product treatment bath, for instance. Furthermore, the exit/entrance cross section of the process cavity may be optionally different from the circular shape discussed above, e.g., by being rectangular, hexagonal, octagonal or having the shape of a bath closed with a planar cover and so on.

Further advantageously, the seal structure may also be used in different kinds of static feedthrough points requiring an easy-to-disassemble mounting arrangement and even to establish sealed conditions for circular objects performing a rotational movement.

The annular member 12 required in the present cavity seal structure may be formed directly onto the wall of the cavity structure or, alternatively, the annular member can be mounted on the cavity structure using other conventional techniques different from welding mentioned above. At any rate, the mounting method must secure good tightness of the cavity seal.

The dimensional stiffness of the cavity seal structure implemented in accordance with the invention allows the structures clamping the seal 13, 13x, that is, the sheet-metal elements 14, 14x and 15, 15x to be fabricated from a substantially thinner material than what has been necessary in prior-art cavity seal assemblies.

Also materials other than sheet metal may be contemplated in the implementation of the invention. For instance, polymer structures produced by injection molding as well as fiber-reinforced composite polymer structures may be equally used to realize a cavity seal structure according to the invention.

The conforming shape of the sheet-metal elements facilitates simple fabrication of the elements from the same blank size in principle for all pipe diameters to be manufactured. Also storage of these sheet-metal elements on one another is uncomplicated as compared with the awkward storage of prior-art ring flanges involving problems due to ring members of different sizes and their projecting threaded bolts hampering stacked storage of the ring members.

The cup-like element formed from sheets 14, 14x and 15, 15x into a piece of revolution may be shaped as desired. The simplest shape herein is a conical cup that may also have curved portions.

1. A seal structure for sealing the inlet/exit gate passageway of an elongated object (1) exiting a process cavity (A, B) or entering such a cavity, the seal structure comprising sheet-metal structures, which essentially delineate said passageway and are removably mounted on the frame structure (3) of said process cavity, and a sweeping seal element (13) held in place by said sheet-metal structures and enclosing said passageway so as to provide a seal against the outer surface of the object traveling through the passageway, characterized in that said sheet-metal structures comprise at least two sheet-metal elements (14, 15, 15x) that have a shape taperingly departing from the frame structure (3) of said process cavity so as to be inclined in the nominal travel direction of the object (1) and are kept compressed mutually against each other so as to clamp a seal element (13, 13x) therebetween.

2. The seal structure of claim 1, characterized in that the angle of inclination (α) of the sheet-metal elements in regard to a plane perpendicular to the longitudinal axis of the object (1) being processed is 15° to 20°.

3. The seal structure of claim 1, characterized in that said sheet-metal elements have a flaringly swaged outer rim portion or the like integral part in a close vicinity of their outer periphery.

4. The seal structure of claim 3, characterized in that said flaringly swaged outer rim portion of said sheet-metal elements has a flaring angle (β) of about 15° in regard to the longitudinal axis of the object (1) being processed.

5. The seal structure of claim 1, characterized in that said sheet-metal elements (14, 15, 15x) are pieces of rotation of a substantially equal shape.

6. The seal structure of claim 5, characterized in that said sheet-metal elements (14, 15, 15x) form a conically stacked structure.

7. The seal structure of claim 5, characterized in that said seal structure includes elements having curved portions.

8. The seal structure of claim 1, characterized in that said mutual compression of the sheet-metal structures (14, 15, 15x) against each other is accomplished by means of the mounting (16) of the sheet-metal elements to the frame structure (3) of the process cavity.

9. The seal structure of claim 1, characterized in that said mutual compression of the sheet-metal structures (14, 15, 15x) against each other is accomplished by means of separate clamp elements (18, 18x).

10. The seal structure of claim 1, characterized in that said sheet-metal elements (15, 15x) have guide projections (19) directed toward said seal elements (13, 13x).

11. The seal structure of claim 1, characterized in that said sheet-metal element (15, 15x) has a friction-improving treatment on the surface (20) thereof forming the sealing interface between said sheet-metal element and said seal element (13, 13x).

12. The seal structure of claim 1, characterized in that said sheet-metal elements (14, 15, 15x) have a leakproofness-improving treatment on the surface thereof forming the sealing interface between said sheet-metal element and said seal element (13, 13x).

13. The seal structure of claim 1, characterized in that the spaces between said sheet-metal elements (14, 15, 15x) are brought to a vacuum.

14. The seal structure of claim 13, characterized in that the spaces between said sheet-metal elements (14, 15, 15x) are provided with channels extending up to the spaces between the seal elements (13, 13x).
